(19) United States
(12) Patent Application Publication
(10) Pub. No.: US 2022/0185417 A1
(43) Pub. Date: Jun. 16, 2022

(54) SCOOTER

(71) Applicant: WU'S TECH CO., LTD., Hsinchu City (TW)

(72) Inventor: Chien-Liang CHIU, Taipei (TW)

(21) Appl. No.: 17/687,850

(22) Filed: Mar. 7, 2022

Related U.S. Application Data
(63) Continuation-in-part of application No. 16/525,036, filed on Jul. 29, 2019.

(30) Foreign Application Priority Data
Jan. 9, 2019 (TW) 108200376

(51) Int. Cl. B62K 15/00; B62K 5/003

(52) U.S. Cl. CPC B62K 15/006; B62K 5/003

(57) ABSTRACT

A scooter features a rear frame with a rear wheelset and a seat and a front frame with a front wheelset and an upright scooter head rod. A telescopic connection frame is installed between the frames with operating mode and folding mode. A bracing plate assembly has front and rear plate bodies disposed on the telescopic connection frame. The front plate body is pivotally connected to the front frame to form a toggle part, and the rear plate body is pivotally connected to the rear frame. The plate bodies are provided with first and second underpropping parts respectively. The height of the toggle part downwards abutting on the bearer part is sufficient for the underpropping parts to abut each other, and the included angle between the top surfaces of the plate bodies is smaller than 180°, so that the zigzag state between the plate bodies is temporarily locked.

### CROSS-REFERENCE TO RELATED U.S. APPLICATIONS

The present application is a continuation-in-part of U.S. Application Ser. No. 16/525,036, filed on Jul. 29, 2019, presently pending.

### BACKGROUND OF THE INVENTION

### 1. Field of the Invention

The present invention relates generally to a scooter, and more particularly to the disclosure of an innovative structure type of a telescopic connecting frame in the operating mode thereof a bracing plate assembly is used for bracing positioning.

### 2. Description of Related Art Including Information Disclosed Under 37 CFR 1.97 and 37 CFR 1.98

There have been many types of electric scooter structure types on the present market, and the electric scooter in the present invention refers to a type wherein the wheel body part thereof is a three-wheel or a four-wheel configuration. This type of electric scooter is widely used by the elderly and the physically handicapped for smooth driving and easy operation.

However, the electric scooter of the type referred to in the present invention also has a problem wherein the scooter body is large in size and relatively occupying the space for placement. Previously, although there have been related industry attempting to develop an improved electric scooter with a scooter body folding function, but its folding effect is not yet perfect.

First, the scooters on the present market can be roughly divided into three major structures: a powered base, a scooter head structure mounted in front of the base, and a seat structure mounted behind the base. The folding method mainly uses the pivot joint structure and the connecting rod structure, so that the folded scooter head structure and the seat structure are as close as possible to the base. However, this folding method only reduces the overall height of the scooter, and the folded scooter still retains the original length of the scooter. In this way, volume is reduced during transportation and storage, but it still occupies a large floor area in the home for the user, and it also causes the current electric scooter to still fail to achieve the practical folding function.

In addition, in terms of prior patent data, a structure of folding plate body is disclosed in the patent for invention of Chinese Mainland “Folding Rear Seat Hopper for Electric wheelchairs” of CN108498247A, but the folding plate body is provided only for reducing the volume of the rear hopper, it has no top bracing positioning action on the frame, because the telescopic rear frame in the case is fixed to the front frame by a screw, and the rear frame can be adjusted steplessly by rotating the screw to achieve a positioning action.

### BRIEF SUMMARY OF THE INVENTION

The primary object of the present invention is to provide a frame structure, and the technical problem to be solved realizes a breakthrough in developing a novel telescopic frame structure of scooter which is more ideal and practical.

The technical feature of the present invention is mainly that said scooter comprises: a rear frame with a front end, a tail end and a top surface, and the rear frame is provided with a rear wheelset, and the front end is formed with two guide runners extended towards the tail end. A seat is connected to the top surface of rear frame by a support. The seat is provided for the user to sit. A front frame is assembled in the spacing at the front end of rear frame, and the front frame is provided with a front wheelset. An upright scooter head rod is assembled on the front frame. The upright scooter head rod is provided for the user to grip with both hands. A telescopic connection frame is installed between the front frame and the rear frame. The telescopic connection frame comprises a front frame part and two sliding bar parts which are connected to each other. The front frame part is connected to the front frame, two sliding bar parts are inserted in the two guide runners of rear frame in telescopic sliding state, and the maximum elongation stroke of each sliding bar part is set by assembling a limiting component to prevent it from escaping the guide runner, forming the operating mode and folding mode of the telescopic connection frame, and a bearer part is formed at least in the midsection of the top surface of each sliding bar part. A bracing plate assembly is assembled between the front frame and rear frame and above the telescopic connection frame. The bracing plate assembly comprises a front plate body and a rear plate body. The front plate body and rear plate body have a front side and a rear side respectively. The front side of the front plate body is pivotally disposed at the rear edge of the front frame through a first pivoting shaft member. The rear side of the rear plate body is pivotally disposed at the front edge of the rear frame through a second pivoting shaft member, and the rear side of the front plate body is pivoted on the front side of the rear plate body through a third pivoting shaft member, and a toggle part is defined at the pivot joint. The toggle part downwards abuts on the bearer part formed on the top surface of each sliding bar part. When the telescopic connection frame is in operating mode, the front and rear plate bodies are interlocked and unfolded taking the third pivoting shaft member as the rotary fulcrum, so as to brace and position the telescopic connection frame in operating mode. Before the unfolded state, the rear plate body is provided for the user to tread on with both feet, when the telescopic connection frame is in folding mode, the front and rear plate bodies are interlocked in zigzag state to release the telescopic connection frame in slideable state. The axle center definition of the first pivoting shaft member forms a first pivoting axis. The axle center definition of the second pivoting shaft member forms a second pivoting axis, and the axle center definition of the third pivoting shaft member forms a third pivoting axis. The connecting definition between the first pivoting axis and the second pivoting axis forms a virtual connecting axis, the virtual connecting axis is in any state of horizontal line or approaching the horizontal line, and the virtual connecting axis corresponding to the third pivoting shaft member defines an intermediate line section, and the height of the third pivoting axis is lower than the height of the intermediate line section. The upper edge of rear side of front plate body and the upper edge of front side of rear plate body are provided with a first underpropping part and a second underpropping part respectively. The height of the toggle part downwards abutting on the bearer part must be sufficient for the first underpropping part and the second underpropping part to abut on each other, and the included angle between the top surfaces of front plate body and rear plate body is smaller than 180°, so that the zigzag state between the front plate body and rear plate body is temporarily locked to achieve the positioning action.

In terms of the effect and advantage of the present invention, when the front plate body and rear plate body of telescopic frame of scooter are in unfolded state, the innovative type of descending pivot joint between the front and rear plate bodies can enhance the stability of the front and rear plate bodies in unfolded state, the probability of arbitrary turn-up and jump in the running process of scooter is reduced effectively. With the technical feature that the upper edge of rear side of front plate body and the upper edge of front side of rear plate body are provided with a first underpropping part and a second underpropping part respectively, when the front frame and rear frame are in unfolded state, the first underpropping part and the second underpropping part abut on each other, so that the front and rear plate bodies are temporarily locked, and the relative positions of front frame and rear frame will not change arbitrarily in the running process of scooter, the service stability and safety of scooter are further enhanced.

### BRIEF DESCRIPTION OF THE SEVERAL VIEWS OF THE DRAWINGS

FIG. 1 is the stereogram of the telescopic connection frame in operating mode in the preferred embodiment of scooter of the present invention.

FIG. 2 is the side view of the telescopic connection frame in operating mode in the preferred embodiment of scooter of the present invention.

FIG. 3 is the exploded view of local components in the preferred embodiment of scooter of the present invention.

FIG. 4 is the cross-sectional view of the sliding bar parts using the limiting components to prevent it from escaping the guide runner.

FIG. 5 is the stereogram of the telescopic connection frame in folding mode in the preferred embodiment of scooter of the present invention.

FIG. 6 is the sectional view of the front and rear plate bodies of telescopic connection frame of the present invention in folded state.

FIG. 7 is the sectional view of the state that the included angle between the unfolded top surfaces of front and rear plate bodies of telescopic connection frame of the present invention is equal to 180°.

FIG. 8 is enlarged view of Mark 8 in FIG. 7.

FIG. 9 is the sectional view of the state that the included angle between the unfolded top surfaces of front and rear plate bodies of telescopic connection frame of the present invention is smaller than 180°.

FIG. 10 is enlarged view of Mark 10 in FIG. 9.

FIG. 11 is the embodiment diagram of one of the front and rear plate bodies of the present invention provided with a fastener.

### DETAILED DESCRIPTION OF THE INVENTION

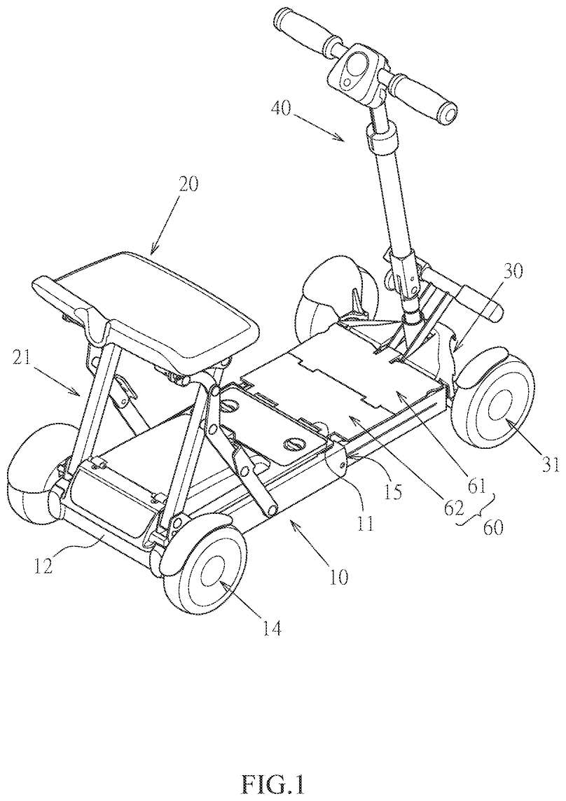

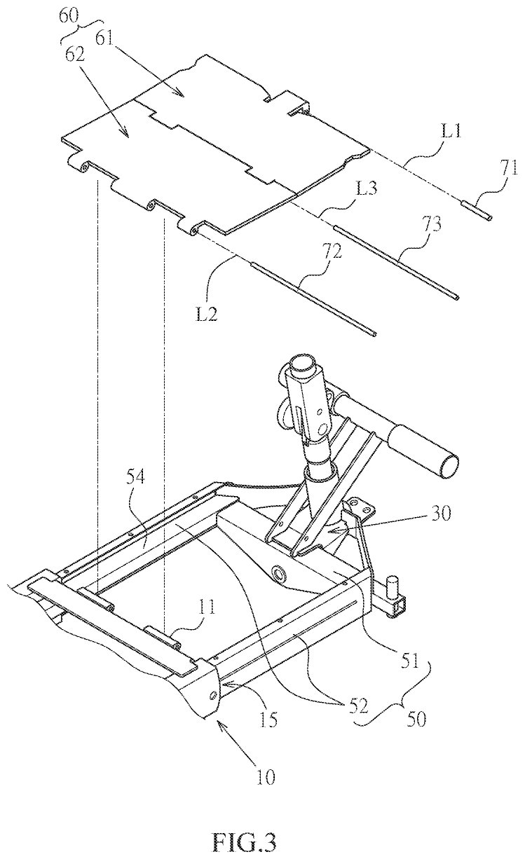

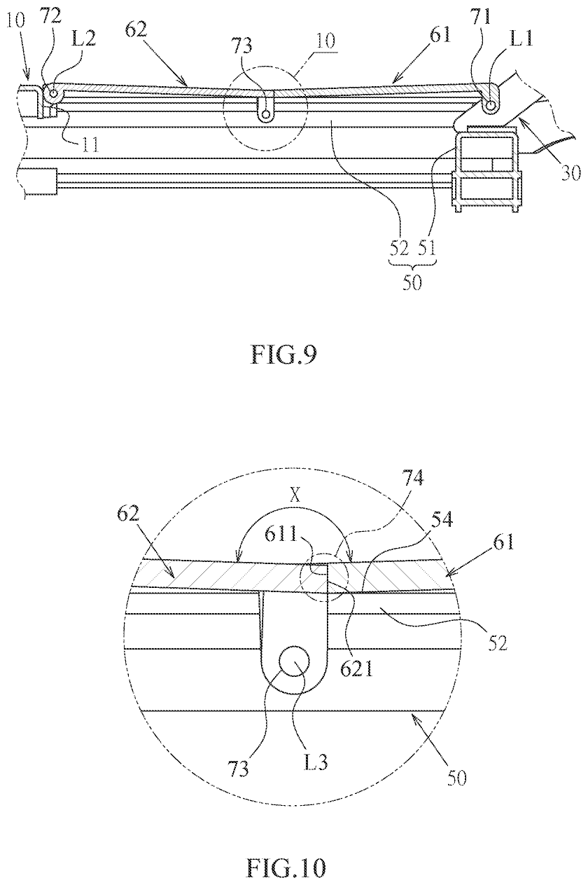

Please refer to FIG. 1 to FIG. 10 for the preferred embodiments of the scooter of the scooter of the present invention. However, these embodiments are for illustrative purposes only and are not limited by the structure in the patent application.

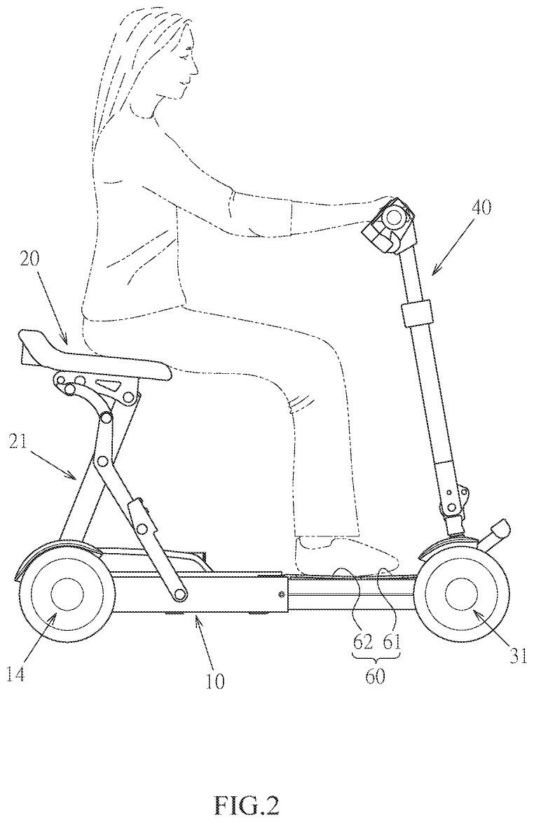

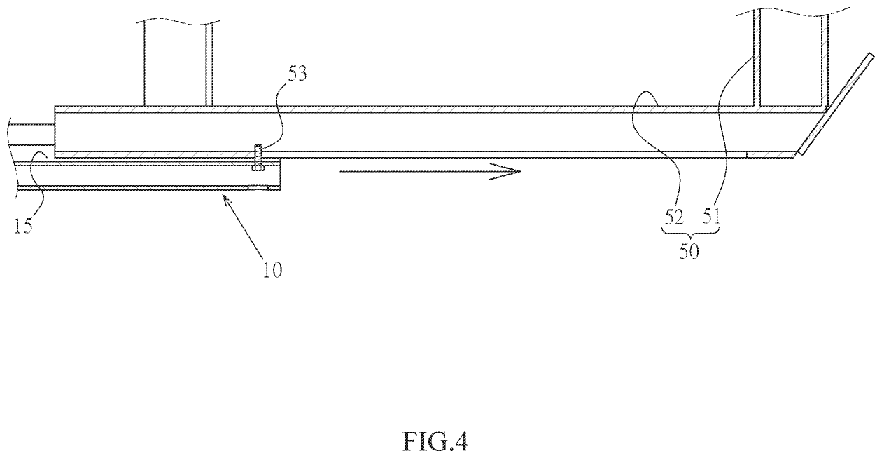

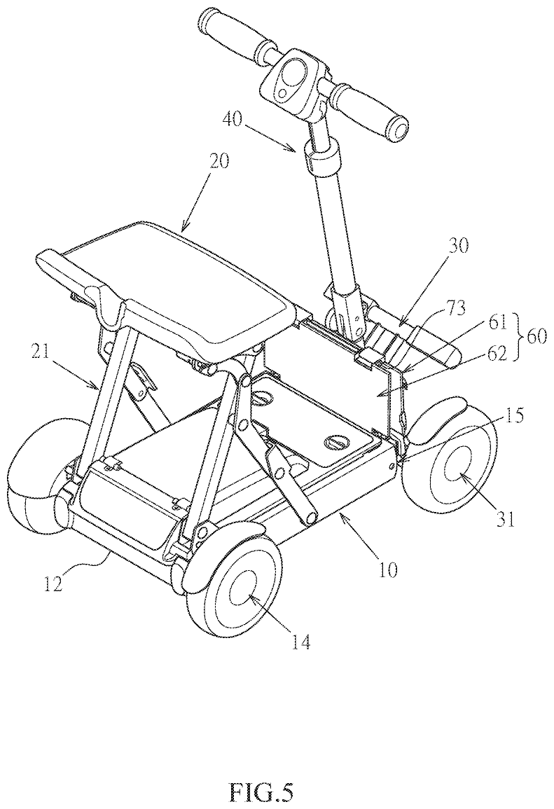

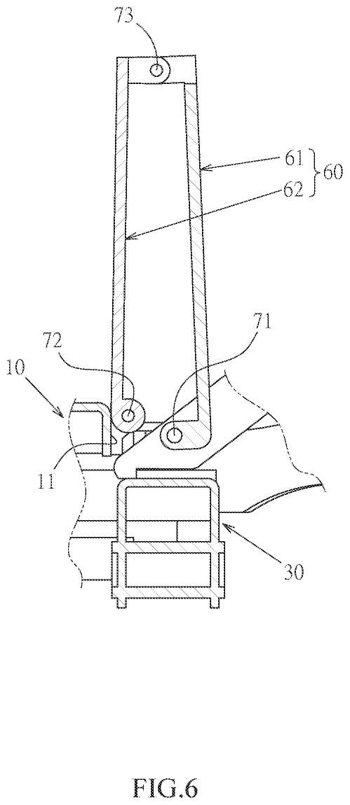

Said scooter comprises a rear frame 10 with a front end 11, a tail end 12 and a top surface 13, and the rear frame 10 is provided with a rear wheelset 14, and the front end 11 is formed with two guide runners 15 extended towards the tail end 12. A seat 20 is connected to the top surface 13 of the rear frame 10 by a support 21. The seat 20 is provided for the user to sit. A front frame 30 is assembled in the spacing at the front end 11 of the rear frame 10, and the front frame 30 is provided with a front wheelset 31. An upright scooter head rod 40 is assembled on the front frame 30. The upright scooter head rod 40 is provided for the user to grip with both hands. A telescopic connection frame 50 is installed between the front frame 30 and the rear frame 10. The telescopic connection frame 50 comprises one front frame part 51 and two sliding bar parts 52 which are connected to each other, wherein the front frame part 51 is connected to the front frame 30, the two sliding bar parts 52 are inserted in the two guide runners 15 of the rear frame 10 in telescopic sliding state, and the maximum elongation stroke of each sliding bar part 52 is set by assembling a limiting component 53 (only marked in FIG. 4) to prevent it from escaping the guide runner 15, forming an operating mode (as shown in FIGS. 1 and 2) and a folding mode (as shown in FIGS. 5 and 6) of the telescopic connection frame 50. A bearer part 54 is formed at least in the midsection of the top surface of the sliding bar part 52. A bracing plate assembly 60 assembled between the front frame 30 and the rear frame 10 and above the telescopic connection frame 50. The bracing plate assembly 60 comprises a front plate body 61 and a rear plate body 62. The front plate body 61 and the rear plate body 62 have a front side and a rear side respectively. The front side of the front plate body 61 is pivotally disposed on the rear edge of the front frame 30 through a first pivoting shaft member 71, the rear side of the rear plate body 62 is pivotally disposed at the front end 11 of the rear frame 10 through a second pivoting shaft member 72, and the rear side of the front plate body 61 is pivoted on the front side of the rear plate body 62 through a third pivoting shaft member 73, and a toggle part 74 is defined at the pivot joint. The toggle part 74 downwards abuts on the bearer part 54 formed by the top surface of the sliding bar part 52. When the telescopic connection frame 50 is in the operating mode, the front plate body 61 and the rear plate body 62 are interlocked and unfolded taking the third pivoting shaft member 73 as the rotary fulcrum, so as to brace and position the telescopic connection frame 50 in operating mode. The front plate body 61 and the rear plate body 62 in unfolded state are provided for the user to tread on with both feet (as shown in FIG. 2). When the telescopic connection frame 50 is in the folding mode, the front plate body 61 and the rear plate body 62 are interlocked in zigzag state (as shown in FIGS. 5 and 6), so as to release the telescopic connection frame 50 in slideable state.

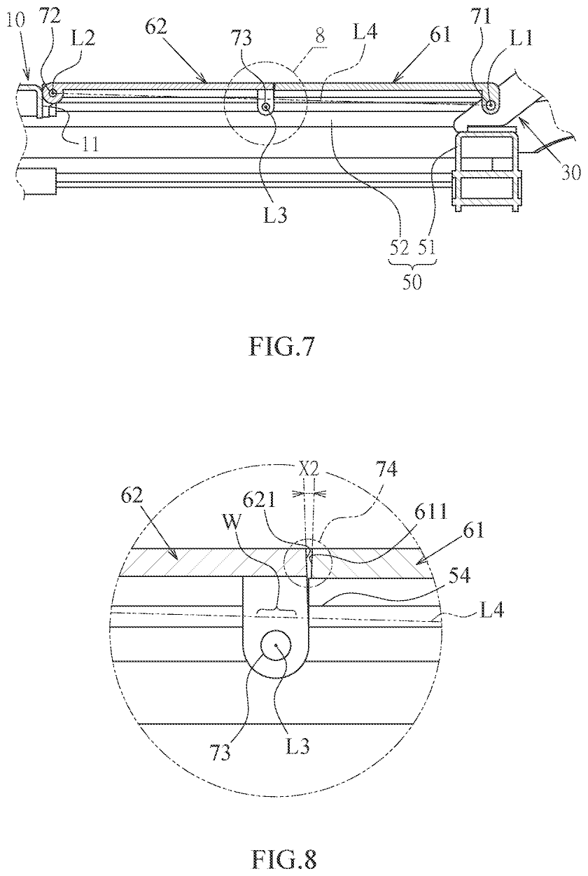

As shown in FIG. 7 and FIG. 8, the axle center of the first pivoting shaft member 71 forms a first pivoting axis L1, the axle center of the second pivoting shaft member 72 forms a second pivoting axis L2, and the axle center of the third pivoting shaft member 73 forms a third pivoting axis L3. The connection between the first pivoting axis L1 and the second pivoting axis L2 forms a virtual connecting axis L4. The virtual connecting axis L4 is in any state of horizontal line or approaching the horizontal line. The part of the virtual connecting axis L4 corresponding to the third pivoting shaft member 73 defines an intermediate line section W, and the height of the third pivoting axis L3 is lower than the height of the intermediate line section W.

Wherein the upper edge of rear side of the front plate body 61 and the upper edge of front side of the rear plate body 62 are provided with a first underpropping part 611 and a second underpropping part 621 respectively, and the height of the toggle part 74 downwards abutting on the bearer part 54 must be sufficient for the first underpropping part 611 and the second underpropping part 621 to abut on each other, forming the state that the included angle between the top surfaces of the front plate body 41 and the rear plate body 42 is smaller than 180° (see X in FIG. 10), so that the zigzag state of the front plate body 41 and the rear plate body 42 is temporarily locked to achieve the positioning action. Therefore, for a running scooter, the relative positions of the front frame 20 and rear frame 10 can be fixed, the operational stability and safety of the scooter are further enhanced.

Based on said structural composition and technical characteristics, the actuation of the preferred embodiments of the present invention is described below: as shown in FIGS. 1 to 2, the scooter is in running state, the operating mode is formed as the front frame 20 extends forward against the rear frame 10 by means of the telescopic connection frame 50, when the front frame 20 and rear frame 10 approach each other under stress (e.g. relative force of components generated during running), as the first underpropping part 611 and the second underpropping part 621 abut on each other, and the included angle between the top surfaces of the front plate body 61 and rear plate body 62 is smaller than 180° (i.e. zigzag surface connection), the zigzag state of the front plate body 61 and rear plate body 62 is temporarily locked and the telescopic connection frame 50 is positioned. Additionally, when the included angle between the top surfaces of the front plate body 61 and rear plate body 62 is equal to 180° during unfolding (i.e. level surface connection), as shown in FIG. 7 to FIG. 8, the first underpropping part 611 and the second underpropping part 621 have an included angle (see X2 in FIG. 8).

Afterwards, when the user applies a force to make the front plate body 61 and rear plate body 62 bend up taking the third pivoting shaft member 73 as rotary fulcrum (as shown in FIG. 5), meaning the folding mode of the telescopic connection frame 50 is formed by interlocking, the front frame 20 is retracted against the rear frame 10 by means of the telescopic connection frame 50, so that the total length of the scooter frame is reduced and favorable for storage.

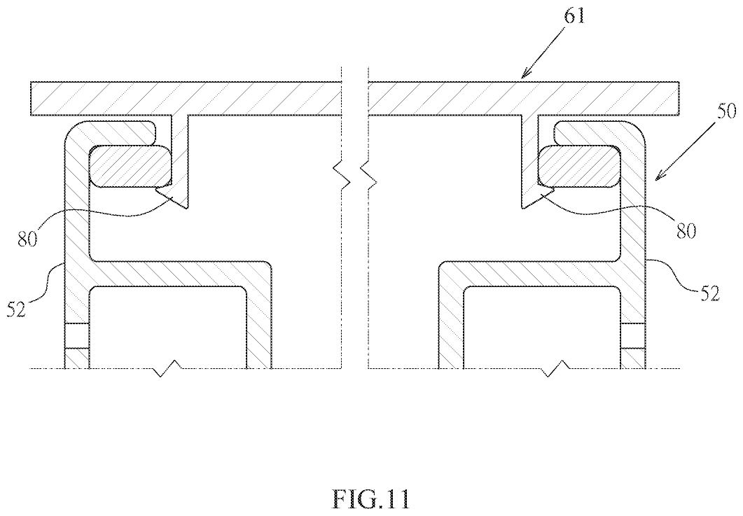

As shown in FIG. 11, the front plate body 61 and rear plate body 62 are alternatively provided with at least one fastener 80. The fastener 80 optionally chucks the sliding bar parts 52 of the telescopic connection frame 50. The purpose of this implementation pattern is to generate appropriate assistant positioning effect on the unfolded state of front plate body 61 and rear plate body 62 by using the fastener 80 to chuck the telescopic connection frame 50, so as to prevent the front plate body 61 and rear plate body 62 from tripping up.

I claim:

1. A scooter, including:
a rear frame with a front end, a tail end and a top surface, and the rear frame is provided with a rear wheelset, and the front end is formed with two guide runners extended towards the tail end;
a seat connected to the top surface of the rear frame through a support, the seat is provided for a user to sit;
a front frame assembled in the spacing at the front end of the rear frame, and the front frame is provided with a front wheelset;
an upright scooter head rod assembled on the front frame, the upright scooter head rod is provided for the user to grip with both hands;
a telescopic connection frame installed between the front frame and the rear frame, the telescopic connection frame comprises a front frame part and two sliding bar parts which are connected to each other, wherein the front frame part is connected to the front frame, the two sliding bar parts are inserted in the two guide runners of the rear frame in telescopic sliding state, and the maximum elongation stroke of the sliding bar parts is set by assembling a limiting component to prevent them from escaping the guide runners, forming an operating mode and a folding mode of the telescopic connection frame, a bearer part is formed in at least the midsection of the top surface of the sliding bar parts; and
a bracing plate assembly assembled between the front frame and the rear frame and above the telescopic connection frame, the bracing plate assembly comprises a front plate body and a rear plate body, the front plate body and the rear plate body have a front side and a rear side respectively, the front side of the front plate body is pivotally disposed on the rear edge of the front frame through a first pivoting shaft member, the rear side of the rear plate body is pivotally disposed on the front edge of the rear frame through a second pivoting shaft member, and the rear side of the front plate body is pivoted on the front side of the rear plate body through a third pivoting shaft member, a toggle part is defined at the pivot joint, the toggle part downwards abuts on the top surface of the sliding bar parts to form the bearer part, when the telescopic connection frame is in the operating mode, the front plate body and the rear plate body are unfolded taking the third pivoting shaft member as rotary fulcrum by interlocking, so as to brace and position the telescopic connection frame in operating mode, the front plate body and the rear plate body in unfolded state are provided for the user to tread on with both feet, when the telescopic connection frame is in the folding mode, the zigzag state of the front plate body and the rear plate body is formed by interlocking, so as to release the telescopic connection frame in slideable state; wherein the axle center of the first pivoting shaft member forms a first pivoting axis, the axle center of the second pivoting shaft member forms a second pivoting axis, the axle center of the third pivoting shaft member forms a third pivoting axis; the connection between the first pivoting axis and the second pivoting axis forms a virtual connecting axis, the virtual connecting axis is in any state of horizontal line or approaching horizontal line, and the part of the virtual connecting axis corresponding to the third pivoting shaft member defines an intermediate line section, and the height of the third pivoting axis is lower than the height of the intermediate line section;
wherein the upper edge of rear side of the front plate body and the upper edge of front side of the rear plate body are provided with a first underpropping part and a second underpropping part respectively, the height of the toggle part downwards abutting on the bearer part must be sufficient for the first underpropping part and the second underpropping part to abut on each other, and the included angle between the top surfaces of the front plate body and the rear plate body is smaller than 180°, so that the zigzag state between the front plate body and the rear plate body is temporarily locked to achieve the positioning action.

2. The telescopic frame structure of scooter defined in claim 1, wherein the front plate body and the rear plate body are alternatively provided with at least one fastener, the fastener optionally chucks the structure of the telescopic connection frame.
